(19) United States
(12) Patent Application Publication
(10) Pub. No.: US 2016/0183159 A1
(43) Pub. Date: Jun. 23, 2016

(54) Service steering method, related device and computer storage medium

(71) Applicant: ZTE CORPORATION, Shenzhen, Guangdong (CN)

(72) Inventors: Yunpeng Cui, Shenzhen (CN); Qian Dai, Shenzhen (CN); Jun Yao, Shenzhen (CN)

(21) Appl. No.: 14/910,357

(22) PCT Filed: Apr. 25, 2014
(86) PCT No.: PCT/CN2014/076281

§ 371 Date: Feb. 5, 2016

(30) Foreign Application Priority Data
Aug. 9, 2013 (CN) 201310345407.3

(51) Int. Cl. H04W 40/02; H04W 36/00; H04W 76/02

(52) U.S. Cl. CPC H04W 40/02; H04W 76/02; H04W 36/0055

(57) ABSTRACT

The embodiment of the present disclosure discloses service steering methods and devices. One service steering method includes that: User Equipment (UE) judges whether it meets a service steering condition or not; and when the UE meets the service steering condition, the UE initiates a Wireless Local Area Network (WLAN) connection establishment according to a principle that preferred processing is for service steering , and steers services to a WLAN. Another service steering method includes that: whether UE meets a service steering condition or not is judged; and when the UE meets the service steering condition, a source network controls the UE to initiate a WLAN connection establishment according to a principle that preferred processing is for service steering , and steers services to a WLAN. The embodiment of the present disclosure correspondingly discloses UE and a source network.

### TECHNICAL FIELD

The present disclosure relates to the field of mobile communications, and in particular to service steering methods, related devices and a computer storage medium.

### BACKGROUND

User Equipment (UE) supports both a fourth-generation wireless communication technology and an Institute of Electrical and Electronic Engineers 802.11 (IEEE802.11)-based Wireless Local Area Network (WLAN) technology. There is much UE with such a dual-mode characteristic, such as a smart phone. A WLAN has high-speed communication performance, so that WLAN is increasingly applied to blind sport coverage and hotspot coverage of 3rd Generation Partnership Project (3GPP) networks.

At present, the following three service steering solutions directed to interworking of a 3GPP network and a WLAN are accepted: in solution 1 and solution 2, UE executes service steering through existing strategy information and auxiliary information, and a difference between solution 1 and solution 2 is that a network side in solution 1 only provides auxiliary information such as a threshold value to assist the UE in network selection and a radio access network in solution 2 may provide auxiliary information similar to that in solution 1 and may also provide strategy information for network selection to assist the UE in network selection. The greatest difference between solution 3 and each of solution 1 and solution 2 is that the determination about whether service steering is performed in solution 3 is controlled by the network side rather than the UE.

Mobility in a 3GPP network is an important issue, a decision about mobility may influence network efficiency and a user experience, and here, mobility refers to handover from a source Evolved Node B (eNB) accessed by UE to a target eNB.

However, there are no norms for behaviours of a network side and UE in case of concurrence of mobility and service steering in present interworking of a 3GPP network and a WLAN, that is, there exists a problem of how to operate in case of coexistence of mobility and service steering, and different mobility and service steering processing mechanisms between the network and the UE may cause a network abnormity, an increase in signalling overhead and the like.

### SUMMARY

In view of this, the embodiments of the present disclosure are mainly intended to provide service steering methods, related devices and a computer storage medium, which may solve the problem of how to operate when mobility and service steering coexist and thus avoid a network abnormity.

To this end, the technical solutions of the present disclosure are implemented as follows.

An embodiment of the present disclosure provides a service steering method, which may include that:

UE judges whether the UE meets a service steering condition or not; and

when the UE meets the service steering condition, the UE initiates a WLAN connection establishment according to a principle that preferred processing is for service steering , and steers services to a WLAN.

Preferably, the method may further include that:

when a service steering decision is to steer all the services to the WLAN, the UE does not execute a handover after receiving from a source network a Radio Resource Control (RRC) connection reconfiguration message with a mobility control Information Element (IE).

Preferably, the method may further include that:

the UE does not send a handover related measurement report to the source network within a first preset time when the service steering decision is to steer all the services to the WLAN, or, a measurement result of the UE meets a condition of triggering a service steering process, or, the UE sends a service steering related measurement report.

Preferably, when the service steering decision is to steer all the services to the WLAN, after the services are steered to the WLAN, the method may further include that: the UE releases an RRC connection.

Preferably, when the service steering decision is to steer part of the services to the WLAN, after the part of the services are steered to the WLAN, the method may further include that: a handover is executed according to an existing protocol specification.

Preferably, the service steering related measurement report and the handover related measurement report are sent using newly defined RRC signalling or measurement report signalling in an existing protocol.

An embodiment of the present disclosure provides a service steering method, which may include that:

whether UE meets a service steering condition or not is judged; and

when the UE meets the service steering condition, a source network controls the UE to initiate a WLAN connection establishment according to a principle that preferred processing is for service steering , and steers services to a WLAN.

Preferably, the method may further include that:

when a service steering decision is to steer all the services to the WLAN, the source network terminates a current handover.

Preferably, when the service steering decision is to steer all the services to the WLAN, the step that the source network controls the UE to initiate the WLAN connection establishment may be that:

the source network controls the UE to initiate the WLAN connection establishment by sending a steering command message to the UE.

Preferably, after the source network sends the steering command message, the method may further include that:

the source network releases an RRC connection.

Preferably, after the source network sends the steering command message, the method may further include that:

the source network does not execute a handover within a second preset time.

Preferably, the steering command message may be:

a newly defined RRC message; or,

a steering add list IE and/or steering release list IE that are/is added into an RRC connection reconfiguration message, wherein the steering add list IE is for representing that an established bearer is configured to load a service steered from the WLAN to a 3GPP network and the steering release list IE is for representing that the services are steered from the 3GPP network to the WLAN.

An embodiment of the present disclosure provides UE, which may include:

a first condition judgment unit, configured to judge whether the UE meets a service steering condition or not; and

a steering unit, configured to, when the UE meets the service steering condition, initiate a WLAN connection establishment according to a principle that preferred processing is for service steering , and steer services to a WLAN.

Preferably, the UE may further include:

a connection establishment control unit, configured to, when a service steering decision is to steer all the services to the WLAN, not execute a handover after receiving an RRC connection reconfiguration message with a mobility control IE from a source network.

Preferably, the UE may further include:

a measurement report control unit, configured to not send a handover related measurement report to the source network within a first preset time, when the service steering decision is to steer all the services to the WLAN, or, a measurement result of the UE meets a condition of triggering a service steering process, or, the UE sends a service steering related measurement report.

An embodiment of the present disclosure provides a source network, which may include:

a second condition judgment unit, configured to judge whether UE meets a service steering condition or not; and

a steering control unit, configured to, when the UE meets the service steering condition, control the UE to initiate a WLAN connection establishment according to a principle that preferred processing is for service steering , and steers services to a WLAN.

Preferably, the source network may further include:

a handover control unit, configured to, when a service steering decision is to steer all the services to the WLAN, terminate a current handover.

A computer storage medium is provided, in which computer-executable instructions may be stored, the computer-executable instruction being configured to execute the abovementioned methods.

From the above, the technical solutions of the embodiments of the present disclosure include that: UE judges whether it meets a service steering condition or not; and when the UE meets the service steering condition, the UE initiates a WLAN connection establishment according to a principle that preferred processing is for service steering, and steers services to the WLAN. In such a manner, the WLAN connection establishment is initiated according to the principle that preferred processing is for service steering , and the services are steered to the WLAN, so that the embodiments of the present disclosure may solve the problem of how to operate in case of coexistence of mobility and service steering to further avoid a network abnormity, save signalling overhead and optimize network performance.

### BRIEF DESCRIPTION OF THE DRAWINGS

FIG. 1 is an implementation flowchart of a service steering method according to an embodiment of the present disclosure;

FIG. 2 is an implementation flowchart of another service steering method according to an embodiment of the present disclosure;

FIG. 3 is a structure diagram of UE according to an embodiment of the present disclosure;

FIG. 4 is a structure diagram of a source network according to an embodiment of the present disclosure;

FIG. 5 is a flowchart of an example of a first embodiment of a service steering method according to the present disclosure;

FIG. 6 is a flowchart of an example of a second embodiment of a service steering method according to the present disclosure;

FIG. 7 is a flowchart of an example of a third embodiment of a service steering method according to the present disclosure; and

FIG. 8 is a flowchart of an example of a fourth embodiment of a service steering method according to the present disclosure.

### DETAILED DESCRIPTION

The present disclosure will be described below with reference to the drawings and embodiments in detail. It is to be noted that the embodiments in the present disclosure and characteristics in the embodiments can be combined under the condition of no conflicts.

An embodiment of the present disclosure provides a service steering method, and as shown in FIG. 1, the method includes:

step 101: UE judges whether it meets a service steering condition or not; and

step 102: when the UE meets the service steering condition, the UE initiates a WLAN connection establishment according to a principle that preferred processing is for service steering , and steers services to a WLAN.

Preferably, the method further includes that:

when a service steering decision is to steer all the services to the WLAN, the UE does not execute a handover after receiving a Radio Resource Control (RRC) connection reconfiguration message with a mobility control Information Element (IE) from a source network.

Here, all the services are:

the sum of Guaranteed Bit Rate (GBR) services and non-GBR services under the same Packet Data Network (PDN) in the same UE; or,

the sum of GBR services and non-GBR services under different PDNs in the same UE.

Preferably, the method further includes that:

the UE does not send a handover related measurement report to the source network within a first preset time,

when the service steering decision is to steer all the services to the WLAN, or,

when a measurement result of the UE meets a condition of triggering a service steering process, or,

when the UE sends a service steering related measurement report.

Preferably, when the service steering decision is to steer all the services to the WLAN, after the services are steered to the WLAN, the method further includes that: the UE releases an RRC connection.

Preferably, when the service steering decision is to steer part of the services to the WLAN, after the part of the services are steered to the WLAN, the method further includes that: a handover is executed according to an existing protocol specification.

Preferably, the service steering related measurement report and the handover related measurement report are sent using newly defined RRC signalling or measurement report signalling in an existing protocol.

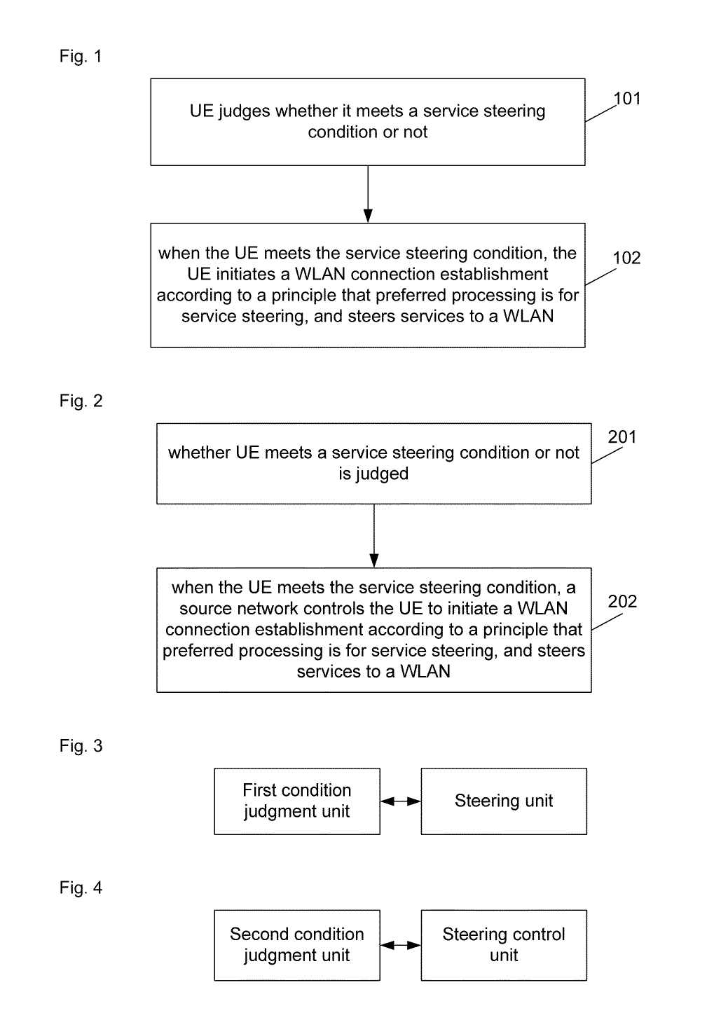

An embodiment of the present disclosure provides another service steering method, and as shown in FIG. 2, the method includes:

step 201: whether UE meets a service steering condition or not is judged; and

step 202: when the UE meets the service steering condition, a source network controls the UE to initiate a WLAN connection establishment according to a principle that preferred processing is for service steering , and steers services to a WLAN.

Preferably, the method further includes that:

when a service steering decision is to steer all the services to the WLAN, the source network terminates a current handover.

Preferably, when the service steering decision is to steer all the services to the WLAN, the step that the source network controls the UE to initiate the WLAN connection establishment is implemented as follows:

the source network controls the UE to initiate the WLAN connection establishment by sending a steering command message to the UE.

Preferably, after the source network sends the steering command message, the method further includes that:

the source network releases an RRC connection.

Preferably, after the source network sends the steering command message, the method further includes that:

the source network does not execute a handover within a second preset time.

Preferably, the steering command message is:

a newly defined RRC message; or,

a steering add list IE and/or steering release list IE added into an RRC connection reconfiguration message, the steering add list IE being used to represent that an established bearer is configured to load a service steered from the WLAN to a 3GPP network and the steering release list IE being used to represent that the services are steered from the 3GPP network to the WLAN.

An embodiment of the present disclosure provides UE, and as shown in FIG. 3, the UE includes:

a first condition judgment unit, configured to judge whether the UE meets a service steering condition or not; and

a steering unit, configured to, when the UE meets the service steering condition, initiate a WLAN connection establishment according to a principle that preferred processing is for service steering , and steer services to a WLAN.

Preferably, the UE further includes:

a connection establishment control unit, configured to, when a service steering decision is to steer all the services to the WLAN, not execute a handover after receiving an RRC connection reconfiguration message with a mobility control IE from a source network.

Preferably, the UE further includes:

a measurement report control unit, configured to not send a handover related measurement report to the source network within a first preset time, when the service steering decision is to steer all the services to the WLAN, or, when a measurement result of the UE meets a condition of triggering a service steering process, or, when the UE sends a service steering related measurement report.

The first condition judgment unit and the steering unit of the UE in the embodiment of the present disclosure may be implemented by a device such as a Central Processing Unit (CPU), a Digital Signal Processor (DSP) and a Field Programmable Gate Array (FPGA).

An embodiment of the present disclosure provides a source network, and as shown in FIG. 4, the source network includes:

a second condition judgment unit, configured to judge whether UE meets a service steering condition or not; and

a steering control unit, configured to, when the UE meets the service steering condition, control the UE to initiate a WLAN connection establishment according to a principle that preferred processing is for service steering, and steers services to a WLAN.

Preferably, the source network further includes:

a handover control unit, configured to, when a service steering decision is to steer all the services to the WLAN, terminate a current handover.

The second condition judgment unit and the steering control unit of the source network in the embodiment of the present disclosure may be implemented by a device such as a CPU, a DSP and an FPGA.

An embodiment of the present disclosure further provides a computer storage medium, in which computer-executable instructions are stored, the computer-executable instructions being configured to execute the abovementioned methods.

The present disclosure will be introduced below with the application of the present disclosure to a Long Term Evolution (LTE) network in detail. In the following embodiments, a source network is a source eNB, and a target network is a target eNB.

### Embodiment 1

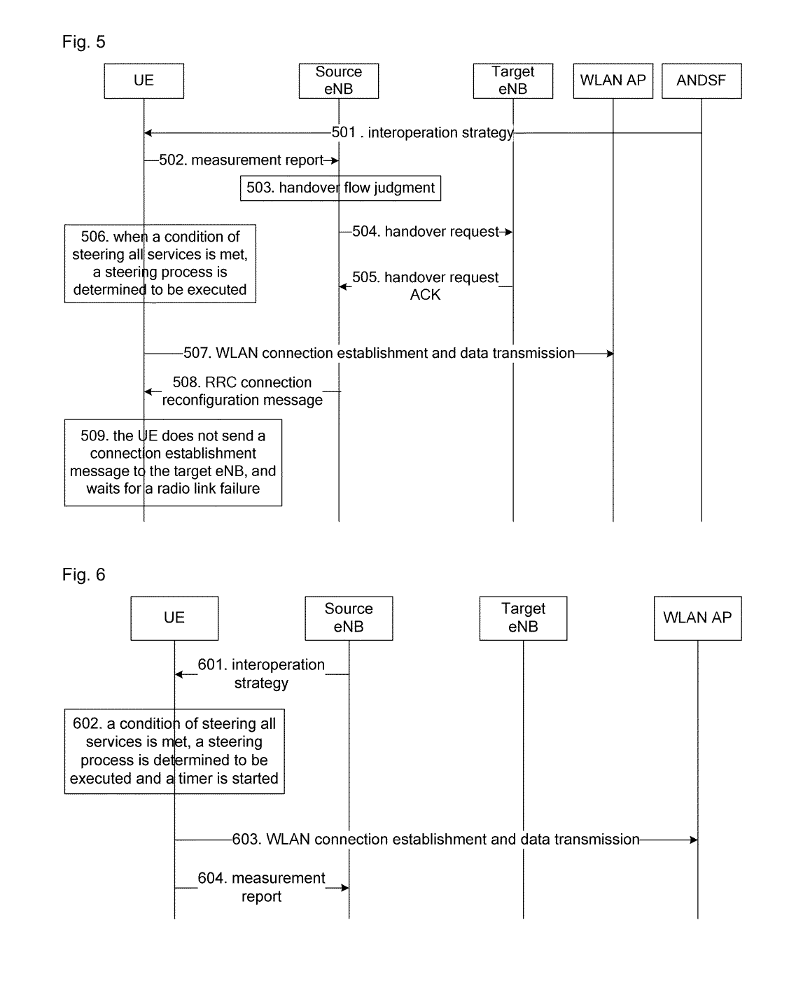

In the embodiment, UE determines to steer all services from a 3GPP network to a WLAN, and does not send a connection establishment message to the target eNB after receiving a handover command, and as shown in FIG. 5, a service steering method provided by the embodiment includes the following steps.

Step 501: the UE obtains an interoperation strategy for the 3GPP network and the WLAN.

In the embodiment, the UE acquires the interoperation strategy from an Access Network Discovery And Selection Function (ANDSF) serving as a network element of a core network.

Step 502: the UE in a connected state judges whether it meets a condition of sending a measurement report or not according to a measurement result, and when the condition of sending the measurement report is met, the UE sends the measurement report to the source eNB on a network side.

In the embodiment, the measurement report is triggered by a handover related measurement event.

Step 503: the source eNB judges whether to perform a handover flow or not after receiving the measurement report from the UE.

In the embodiment, the source eNB determines whether to execute a handover or not according to the measurement report.

Step 504: the source eNB sends a handover request to the target eNB.

In the embodiment, the source eNB sends the handover request to the target eNB meeting a condition.

Step 505: the target eNB accepts the handover request of the source eNB after receiving the handover request from the source eNB, and sends a handover request Acknowledgement (ACK) to the source eNB.

In the embodiment, the target eNB accepts the handover request, and sends the handover request ACK to the source eNB.

Step 506: the UE executes measurement according to the acquired interoperation strategy, and determines to execute a steering process when a condition of steering all services is met.

In the embodiment, the UE executes measurement according to the interoperation strategy acquired from the ANDSF, judges whether the condition of steering all the services is met or not, and determines to execute the steering process when the condition of steering all the services is met.

Step 506 may be executed before Step 505, or Step 504, or Step 503, or Step 502.

Step 507: the UE initiates a WLAN connection establishment, and steers all the services to the WLAN.

In the embodiment, the UE executes the WLAN connection establishment immediately when finishing executing Step 506, and steers all the services to the WLAN after a connection is successfully established.

Step 508: the source eNB sends an RRC connection reconfiguration message to the UE, the message containing a mobility control IE.

In the embodiment, the source eNB sends the RRC connection reconfiguration message with the mobility control IE to the UE to notify the UE to execute handover operation.

Step 509: the UE does not send the connection establishment message to the target eNB according to a principle that service steering is preferred.

In the embodiment, the UE does not send the connection establishment message to the target eNB according to the principle that service steering is preferred, and waits for a radio link failure, and the UE is then reconnected to a new network, i.e. the WLAN, through an RRC connection reestablishment.

### Embodiment 2

In the embodiment UE determines to steer all services to a WLAN, the UE does not send a handover related measurement report within a unit time T1, and as shown in FIG. 6, a service steering method provided by the embodiment includes the following steps.

Step 601: the UE obtains an interoperation strategy for a 3GPP network and the WLAN.

In the embodiment, the UE acquires the interoperation strategy from a source eNB.

Step 602: the UE executes measurement according to the acquired interoperation strategy, determines to execute a steering process when a condition of steering all the services is met, starts a timer, and does not send a measurement report to the source eNB on a network side during running of the timer.

In the embodiment, the UE executes measurement according to the interoperation strategy acquired from the source eNB, judges whether the condition of steering all the services is met or not, and determines to execute the steering process when the condition of steering all the services is met. The timer configured to control a handover related measurement report is started, and sending of the measurement report to the source eNB on the network side during running of the timer is forbidden.

Step 603: the UE initiates a WLAN connection establishment, and steers all the services to the WLAN.

In the embodiment, the UE executes the WLAN connection establishment immediately when finishing executing Step 603, and steers all the services to the WLAN after a connection is successfully established.

Step 604: the UE in a connected state judges whether it meets a condition of sending a measurement report or not according to a measurement result, and sends the measurement report to the source eNB on the network side when the condition of sending the measurement report is met and the timer stops running.

In the embodiment, the measurement report is triggered by a handover related measurement event, and the UE does not send the triggered measurement report according to a principle that service steering is preferred when the timer set in Step 602 still runs.

### Embodiment 3

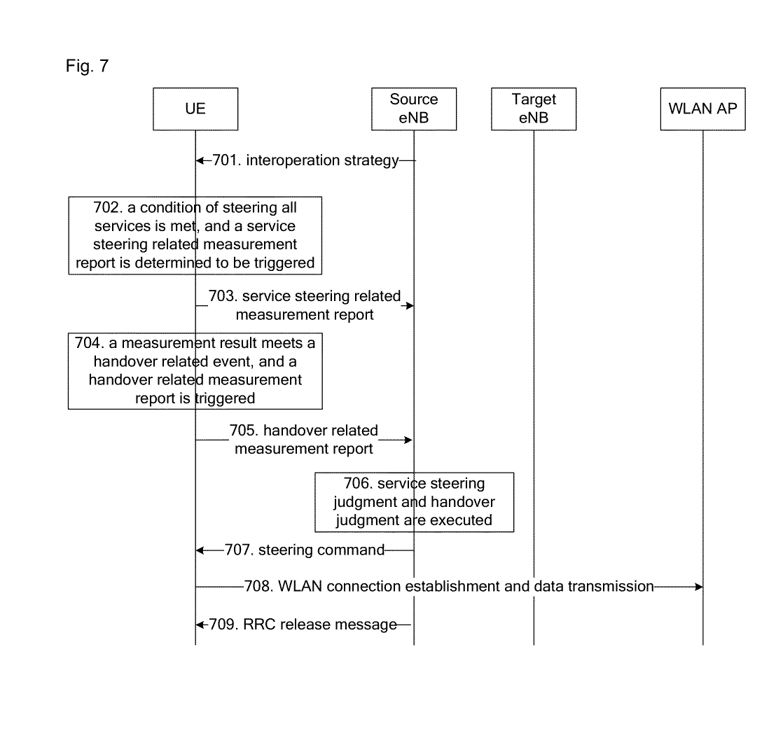

In the embodiment, a network side determines to steer all services to a WLAN, a source eNB releases an RRC connection after sending a steering command message to UE, and as shown in FIG. 7, a service steering method provided by the embodiment includes the following steps.

Step 701: the UE obtains an interoperation strategy for a 3GPP network and the WLAN.

In the embodiment, the UE acquires the interoperation strategy from a source eNB serving as a network element of an access network.

Step 702: the UE determines to trigger a service steering related measurement report when judging that a condition of steering all the services is met according to the obtained interoperation strategy.

In the embodiment, the UE executes measurement according to the acquired interoperation strategy, and triggers the service steering related measurement report when determining that the condition of steering all the services to the WLAN is met according to a measurement result.

Step 703: the UE sends the service steering related measurement report to the source eNB.

In the embodiment, the UE sends the service steering related measurement report to the source eNB by a measurement report message.

Step 704: the UE performs measurement, and triggers a handover related measurement report when the measurement result meets a handover related event.

In the embodiment, the UE judges whether a mobility measurement event triggering condition is met or not according to the obtained measurement result.

Step 705: the UE sends the handover related measurement report to the source eNB.

In the embodiment, the UE sends a mobility related measurement report to the source eNB on the network side to assist the network side in handover judgment according to the obtained measurement result.

Step 706: the source eNB on the network side executes service steering judgment and handover judgment after receiving the service steering related measurement report and handover related measurement report sent by the UE.

In the embodiment, the source eNB performs service steering judgment and handover judgment after receiving the service steering related measurement report and handover related measurement report from the UE, and the eNB determines to execute service steering operation according to a principle that service steering is preferred, and does not send handover request signalling to a target eNB.

Step 707: the source eNB sends a steering command message to the UE.

In the embodiment, the source eNB judges whether the measurement reports reported by the UE meet a request of steering all the services or not, and sends the steering command message to the UE to command the UE to execute service steering operation.

Step 708: the UE initiates a WLAN connection establishment after receiving the steering command message.

In the embodiment, the UE initiates the connection establishment to a WLAN Access Point (AP) after receiving the steering command message from the eNB, and performs data transmission after a connection is successfully established.

Step 709: the source eNB sends an RRC release message to the UE after finishing sending the steering command message.

In the embodiment, the source eNB releases the RRC connection immediately when sending the steering command message to the UE according to the principle that service steering is preferred.

Step 709 may be initiated before Step 708.

### Embodiment 4

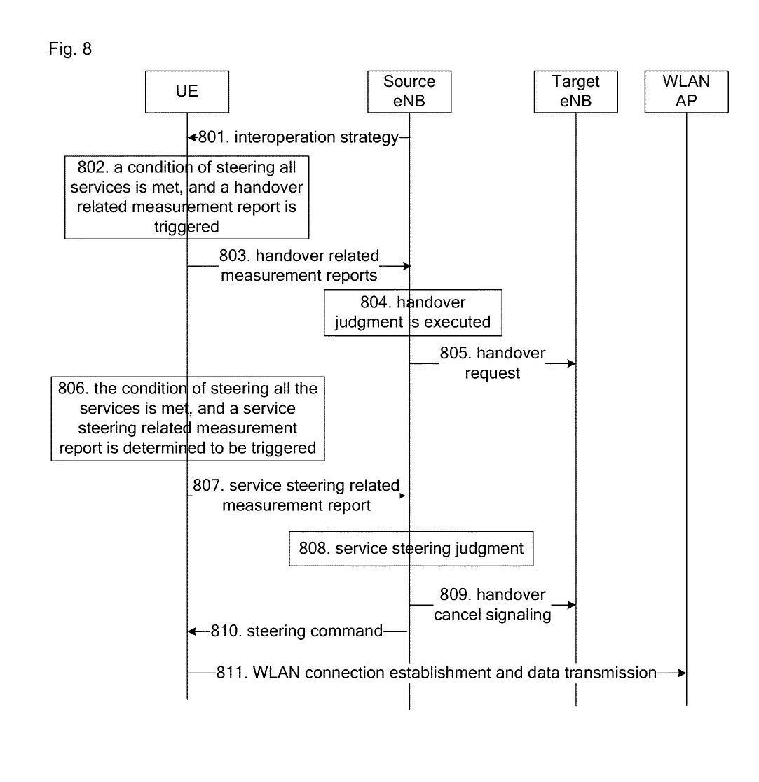

In the embodiment, a network side determines to steer all services to a WLAN, a source eNB terminates a current handover, and as shown in FIG. 8, a service steering method provided by the embodiment includes the following steps:

Step 801: UE obtains an interoperation strategy for a 3GPP network and the WLAN.

In the embodiment, the UE acquires the interoperation strategy from the source eNB serving as a network element of an access network.

Step 802: the UE performs measurement, and triggers a handover related measurement report when a measurement result meets a handover related event.

In the embodiment, the UE judges whether a condition of triggering a mobility measurement event is met or not according to the obtained measurement result.

Step 803: the UE sends a handover related measurement report to the source eNB on the network side.

In the embodiment, the UE sends the handover related measurement report to the source eNB on the network side to assist the network side in handover judgment according to the obtained measurement result.

Step 804: the source eNB on the network side executes a handover judgment after receiving the handover related measurement report from the UE.

In the embodiment, the networek side executes a handover judgment after receiving the handover related measurement report from the UE, and determines to switch the UE to a target eNB.

Step 805: the source eNB sends a handover request to the target eNB.

In the embodiment, the source eNB sends the handover request to the target eNB to switch the UE meeting a handover condition to the target eNB.

Step 806: the UE determines to trigger a service steering related measurement report when determining that a condition of steering all the services is met according to the obtained interoperation strategy.

In the embodiment, the UE triggers the service steering related measurement report when determining that the condition of steering all the services to the WLAN is met according to the measurement result.

Step 807: the UE sends the service steering related measurement report to the source eNB on the network side.

In the embodiment, the UE sends the service steering related measurement report to the source eNB by a measurement report message.

Step 808: the source eNB on the network side executes a service steering judgment according to the received measurement report related to the service steering.

In the embodiment, the source eNB executes a service steering judgment after receiving the service steering related measurement report from the UE, the source eNB determines that it is necessary to execute service steering operation according to a principle that service steering is preferred, and the source eNB stops the current handover after making a service steering decision if the handover is being executed.

Step 809: the source eNB sends handover cancel signalling to the target eNB to terminate the current handover.

In the embodiment, the source eNB sends the handover cancel signalling to the target eNB to terminate the current handover according to the principle that service steering is preferred after making the service steering decision.

Step 810: the source eNB sends a steering command message to the UE.

In the embodiment, the source eNB determines that the measurement reports reported by the UE meet a request of steering all the services, and sends the steering command message to the UE to command the UE to execute service steering operation.

Step 811: the UE initiates a WLAN connection establishment after receiving the steering command message.

In the embodiment, the UE initiates the connection establishment directed to a WLAN AP after receiving the steering command message sent by the source eNB, and performs data transmission after a connection is successfully established.

During a practical application, the embodiment of the present disclosure is also applicable to a Universal Mobile Telecommunications System (UMTS), and the application of the embodiment of the present disclosure to a UMTS network is similar to the application of the embodiment of the present disclosure to the LTE network, and will not be elaborated.

Each unit may be implemented by a CPU, DSP or FPGA in electronic equipment.

Those skilled in the art should know that the embodiments of the present disclosure may be provided as a method, a system or a computer program product. Therefore, the present disclosure may adopt a pure hardware embodiment, a pure software embodiment and a combined software and hardware embodiment. Moreover, the present disclosure may adopt a computer program product implemented on one or more computer-available storage media (including, but not limited to, a disk memory, a Compact Disc Read-Only Memory (CD-ROM) and an optical memory) including computer-available program codes.

The present disclosure is described with reference to flowcharts and/or block diagrams of the method, the equipment (system) and the computer program product according to the embodiments of the present disclosure. It should be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to work in a specific manner, so that a product including an instruction device may be generated by the instructions stored in the computer-readable memory, the instruction device realizing the function specified in one flow or many flows in the flowcharts and/or one block or many blocks in the block diagrams.

These computer program instructions may further be loaded onto a computer or other programmable data processing equipment, so that a series of operating steps are executed on the computer or the other programmable data processing equipment to generate processing implemented by the computer, and steps for realizing the function specified in one flow or many flows in the flowcharts and/or one block or many blocks in the block diagrams are provided by the instructions executed on the computer or the other programmable data processing equipment.

The above are only the preferred embodiments of the present disclosure and not intended to limit the present disclosure, and for those skilled in the art, the present disclosure may have various modifications and variations. Any modifications, equivalent replacements, improvements and the like made within the spirit and principle of the present disclosure shall fall within the scope of protection of the present disclosure.

### INDUSTRIAL APPLICABILITY

Based on the technical solutions of the embodiments of the present disclosure, UE judges whether it meets a service steering condition or not; and when the UE meets the service steering condition, the UE initiates a WLAN connection establishment according to a principle that preferred processing is for service steering , and steers the services to the WLAN. In such a manner, the WLAN connection establishment is initiated according to the principle that preferred processing is for service steering , and the services are steered to the WLAN, so that the embodiments of the present disclosure may solve the problem of how to operate in case of coexistence of mobility and service steering to further avoid a network abnormity, save signalling overhead and optimize network performance.

What is claimed is:

1. A service steering method, comprising:
judging, by User Equipment (UE), whether the UE meets a service steering condition or not; and
when the UE meets the service steering condition, initiating, by the UE, a Wireless Local Area Network (WLAN) connection establishment according to a principle that preferred processing is for service steering, and steering services to a WLAN.

2. The method according to claim 1, further comprising:
when a service steering decision is to steer all the services to the WLAN, not executing, by the UE, a handover after receiving from a source network a Radio Resource Control (RRC) connection reconfiguration message with a mobility control Information Element (IE).

3. The method according to claim 1, further comprising:
not sending, by the UE, a handover related measurement report to the source network within a first preset time when the service steering decision is to steer all the services to the WLAN, or, a measurement result of the UE meets a condition of triggering a service steering process, or, the UE sends a service steering related measurement report.

4. The method according to claim 1, when the service steering decision is to steer all the services to the WLAN, after steering the services to the WLAN, the method further comprising: releasing, by the UE, an RRC connection.

5. The method according to claim 1, when the service steering decision is to steer part of the services to the WLAN, after steering the part of the services to the WLAN, the method further comprising: executing a handover according to an existing protocol specification.

6. The method according to claim 3, wherein the service steering related measurement report and the handover related measurement report are sent using newly defined RRC signalling or measurement report signalling in an existing protocol.

7. A service steering method, comprising:
judging whether User Equipment (UE) meets a service steering condition or not; and
when the UE meets the service steering condition, controlling, by a source network, the UE to initiate a Wireless Local Area Network (WLAN) connection establishment according to a principle that preferred processing is for service steering, and steering services to a WLAN.

8. The method according to claim 7, further comprising:
when a service steering decision is to steer all the services to the WLAN, terminating, by the source network, a current handover.

9. The method according to claim 7, wherein, when the service steering decision is to steer all the services to the WLAN, controlling, by the source network, the UE to initiate the WLAN connection establishment is:
controlling, by the source network, the UE to initiate the WLAN connection establishment by sending a steering command message to the UE.

10. The method according to claim 9, after sending, by the source network, the steering command message, the method further comprising:
releasing, by the source network, a Radio Resource Control (RRC) connection.

11. The method according to claim 9, after sending, by the source network, the steering command message, the method further comprising:
not executing, by the source network, a handover within a second preset time.

12. The method according to claim 9, wherein the steering command message is:
a newly defined RRC message; or,
a steering add list Information Element (IE) and/or steering release list IE that are/is added into an RRC connection reconfiguration message, wherein the steering add list IE is for representing that an established bearer is configured to load a service steered from the WLAN to a 3rd Generation Partnership Project (3GPP) network and the steering release list IE is for representing that the services are steered from the 3GPP network to the WLAN.

13. User Equipment (UE), comprising:
a first condition judgment unit, configured to judge whether the UE meets a service steering condition or not; and
a steering unit, configured to, when the UE meets the service steering condition, initiate a Wireless Local Area Network (WLAN) connection establishment according to a principle that preferred processing is for service steering , and steer services to a WLAN.

14. The UE according to claim 13, further comprising:
a connection establishment control unit, configured to, when a service steering decision is to steer all the services to the WLAN, not execute a handover after receiving a Radio Resource Control (RRC) connection reconfiguration message with a mobility control Information Element (IE) from a source network.

15. The UE according to claim 13, further comprising:
a measurement report control unit, configured to not send a handover related measurement report to the source network within a first preset time when the service steering decision is to steer all the services to the WLAN, or, a measurement result of the UE meets a condition of triggering a service steering process, or, the UE sends a service steering related measurement report.

16. A source network, comprising:
a second condition judgment unit, configured to judge whether User Equipment (UE) meets a service steering condition or not; and
a steering control unit, configured to, when the UE meets the service steering condition, control the UE to initiate a Wireless Local Area Network (WLAN) connection establishment according to a principle that preferred processing is for service steering , and steers services to a WLAN.

17. The source network according to claim 16, further comprising:
a handover control unit, configured to, when a service steering decision is to steer all the services to the WLAN, terminate a current handover.

18. A computer storage medium storing computer-executable instructions which are configured to execute the method according to claim 1.

19. A computer storage medium storing computer-executable instructions which are configured to execute the method according to claim 2.

20. A computer storage medium storing computer-executable instructions which are configured to execute the method according to claim 7.
